(19) United States
(12) Patent Application Publication
(10) Pub. No.: US 2025/0053985 A1
(43) Pub. Date: Feb. 13, 2025

(54) METHOD AND SYSTEM FOR CRYPTOCURRENCY FRAUD DETECTION

(71) Applicant: Mastercard International Incorporated, Purchase, NY (US)

(72) Inventors: Eric MOY, New York, NY (US); Ranjana RAJENDRAN, Seattle, WA (US); Chaoyue TAN, Belmont, CA (US); Meghana SANTHAPUR, Wentzville, MO (US); Ally ZHANG, Arlington, VA (US)

(21) Appl. No.: 18/233,068

(22) Filed: Aug. 11, 2023

(51) Int. Cl. G06Q 20/40; G06Q 20/38

(52) U.S. Cl. CPC G06Q 20/4016; G06Q 20/389

(57) ABSTRACT

A method for fraud scoring a cryptographic currency transaction using multiple data sets and graphical modeling includes: receiving transaction data for a plurality of fiat currency based payment transactions from a first computing system; receiving transaction data for a plurality of cryptographic currency based blockchain transactions from a second computing system; receiving node connectivity data for a blockchain network from a third computing system; generating a fraud detection model based on the node connectivity data including generating a graphical representation of the node connectivity data; receiving transaction data for a new blockchain transaction from a computing device; generating a fraud score for the new transaction using the fraud detection model, the transaction data for the fiat currency based transactions, and the transaction data for the cryptographic currency based transactions; and transmitting the generated fraud score to the computing device.

### FIELD

The present disclosure relates to fraud detection in cryptocurrency, specifically the use of multiple data sets and graphical modeling for fraud scoring cryptographic currency transactions.

### BACKGROUND

Blockchain was created as a technology for use in transacting with cryptographic currency, also known as blockchain currency, in a system that is anonymous and decentralized. These features of blockchains can provide for a number of advantages over traditional, fiat-based payment transaction systems, such as providing anonymity for participants so that their behaviors and spending patterns cannot be tracked, using a currency that is not tied to fiat currency and subject to the volatility of traditional currencies, and not being subject to any central authority or system and thus subject to less rules and regulations.

Because transactions in a blockchain are typically anonymous with little to no oversight, blockchain transactions do not benefit from the myriad of consumer advantages developed over the years in traditional, fiat-based payment transactions. For instance, a consumer using a credit card has significant protections against fraud, identity theft, merchant misbehavior, etc. as provided by credit card processors, financial institutions, and payment networks, while blockchains do not provide participants with protections against any of these circumstances except what is afforded by the decentralized and immutable nature of the blockchain. Some entities operate as exchanges that control a participant's blockchain wallet on their behalf, and can therefor provide protection against identity theft or wallet theft, but these entities cannot provide protection against fraudulent transactions. While most credit card transactions are settled via fiat currency, some transactions can be denominated in cryptocurrencies or be associated with the cryptocurrencies writ large. These transactions are often significantly riskier to process for credit card companies given the lack of transparency of the sector. Current fraud scoring methodologies can be quite generalized for various transactions, but do not take into consideration the risk factors associated with cryptocurrencies specifically.

Thus, there is a need for a technological improvement to existing systems to provide for fraud protection for new cryptographic currency transactions.

### SUMMARY

The present disclosure provides a description of systems and methods for fraud scoring cryptographic currency transactions using multiple data sets and graphical modeling. A processing server receives transaction data for traditional, fiat-based payment transactions, transaction data for blockchain transactions, and node connectivity data for a blockchain network on which a new transaction is being initiated. The processing server generates a fraud detection model that, as part of the model, generates a graphical representation of at least the blockchain network, which can illustrate the nodes in the blockchain network and connections thereof. When the processing server receives transaction data for a new blockchain transaction, such as from the potential payer of the transaction, the processing server uses the fraud detection model and transaction data for past fiat-based payment transactions and blockchain transactions to generate a fraud score for the new blockchain transaction that indicates a likelihood of fraud for the new transaction. The fraud score is provided back to the requestor, who can then decide whether or not to proceed with the new blockchain transaction based on the provided fraud score. In some cases, the disposition of the new transaction can be used to further train the fraud detection model for use in future transactions.

A method for fraud scoring a cryptographic currency transaction using multiple data sets and graphical modeling includes: receiving, by a receiver of a processing server, transaction data for a plurality of fiat currency based payment transactions from a first computing system; receiving, by the receiver of the processing server, transaction data for a plurality of cryptographic currency based blockchain transactions from a second computing system; receiving, by the receiver of the processing server, node connectivity data for a blockchain network from a third computing system; generating, by a processor of the processing server, a fraud detection model based on at least the received node connectivity data, wherein generating the fraud detection model includes generating a graphical representation of the received node connectivity data; receiving, by the receiver of the processing server, transaction data for a new blockchain transaction from a computing device; generating, by the processor of the processing server, a fraud score for the new blockchain transaction using a combination of at least the generated fraud detection model, the transaction data for the plurality of fiat currency based payment transactions, and the transaction data for the plurality of cryptographic currency based blockchain transactions; and transmitting, by a transmitter of the processing server, the generated fraud score to the computing device.

A system for fraud scoring a cryptographic currency transaction using multiple data sets and graphical modeling includes: a first computing system; a second computing system; a third computing system; a computing device; a blockchain network; and a processing server, the processing server including a receiver receiving transaction data for a plurality of fiat currency based payment transactions from the first computing system, transaction data for a plurality of cryptographic currency based blockchain transactions from the second computing system, and node connectivity data for the blockchain network from the third computing system, a processor generating a fraud detection model based on at least the received node connectivity data, wherein generating the fraud detection model includes generating a graphical representation of the received node connectivity data, and a transmitter, wherein the receiver of the processing server further receives transaction data for a new blockchain transaction from the computing device, the processor of the processing server generates a fraud score for the new blockchain transaction using a combination of at least the generated fraud detection model, the transaction data for the plurality of fiat currency based payment transactions, and the transaction data for the plurality of cryptographic currency based blockchain transactions, and the transmitter of the processing server transmits the generated fraud score to the computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for fraud scoring cryptographic currency transactions in accordance with exemplary embodiments.

FIG. 2 is a block diagram illustrating the processing server in the system of FIG. 1 for scoring cryptographic currency transactions in accordance with exemplary embodiments.

FIG. 3 is a flow diagram illustrating a process for generating a fraud detection model for use in fraud scoring cryptographic currency transactions by the processing server in the system of FIG. 1 in accordance with exemplary embodiments.

FIG. 4 is a diagram illustrating a graphical representation for a fraud detection model used in fraud scoring cryptographic currency transactions in accordance with exemplary embodiments.

FIG. 5 is a flow diagram illustrating a process for fraud scoring a cryptographic currency transaction in the system of FIG. 1 in accordance with exemplary embodiments.

FIG. 6 is a flow chart illustrating an exemplary method for fraud scoring a cryptographic currency transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Fraud Scoring Cryptographic Currency Transactions

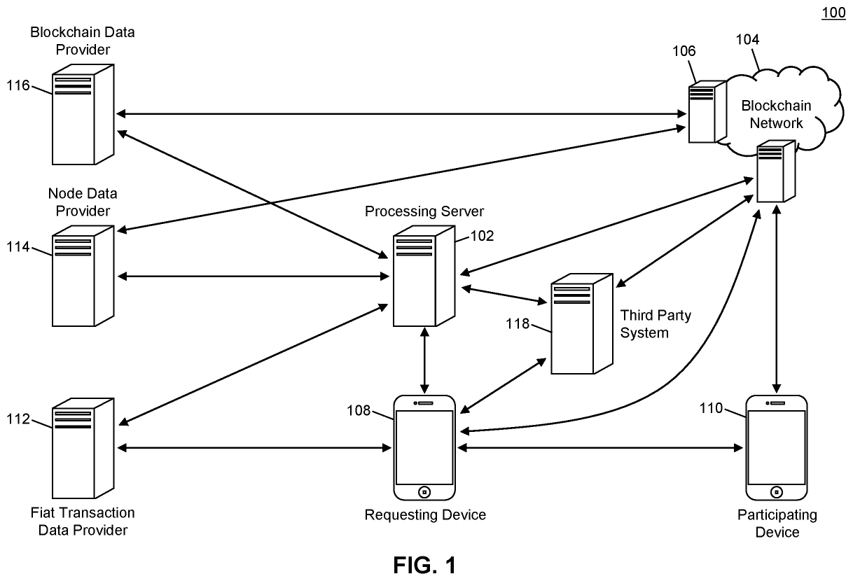

FIG. 1 illustrates a system 100 for the generation and use of a fraud score for a cryptographic currency transaction based on multiple data sets and a graphical representation.

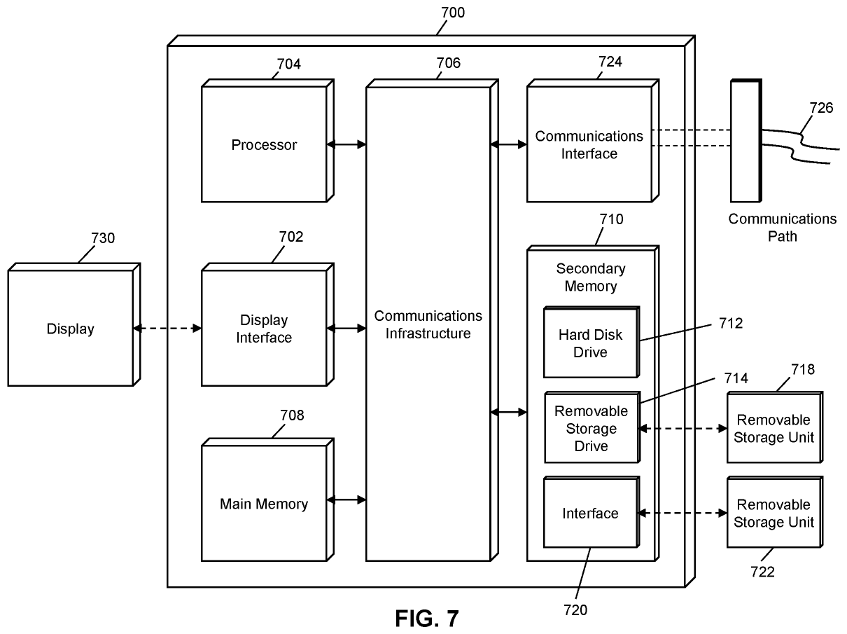

The system 100 can include a processing server 102. The processing server 102, discussed in more detail below, can be configured to generate fraud detection models that include a graphical representation and calculate fraud scores for new cryptographic currency transactions on a blockchain using the fraud detection model and data received from multiple sources. The system 100 can further include a blockchain network 104 associated with a blockchain on which the new blockchain transaction is, if approved, to be added. The blockchain network 104 can be comprised of a plurality of blockchain nodes 106. Each blockchain node 106 can be a computing system, such as illustrated in FIG. 7, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device (e.g., requesting device 108, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a requesting device 108) that is generated using the sender's private key, a blockchain address of the recipient of currency (e.g., participating device 110) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

As discussed herein, blockchain currency, also referred to as cryptographic currency, can refer to any asset that can be stored on a blockchain and transferred through the use of a blockchain transaction. Blockchain currency can include any cryptographic currency, stablecoins (e.g., blockchain currency tied to a fiat currency or other asset), non-fungible token, digital token, fiat currency as stored on a blockchain, etc.

In the system 100, a user of a requesting device 108 can be interested in participating in a new blockchain transaction that is to be added to the blockchain associated with the blockchain network 104. The requesting device 108 can participate in the new blockchain transaction as a payer or payee and can also participate in the new blockchain transaction with a participating device 110, which can be the sender or recipient of cryptographic currency to or from the requesting device 108, as applicable. To initiate a new blockchain transaction, the requesting device 108 can receive the necessary data for a new blockchain transaction, which can include a destination blockchain address (e.g., generated by the public key of the participating device 110 and electronically transmitted to the requesting device 108) using a suitable communication network and method) and a cryptographic currency amount if the requesting device 108 is a payer, or digital signature and one or more unspent transaction outputs from the requesting device 108, a cryptographic currency amount, and a destination address generated by the public key of the requesting device's blockchain wallet if the requesting device 108 is a payee. Traditionally, the requesting device 108 can electronically transmit the transaction data for the new blockchain transaction to a blockchain node 106 in the blockchain network 104 for verification, confirmation, and addition to the blockchain using traditional methods.

In the system 100, the user of the requesting device 108 can be interested in having a fraud score generated for the new blockchain transaction prior to, or as part of, submission to the blockchain node 106. For instance, the user can be participating in a blockchain transaction with the participant device 110 for the first time, and may be interested in a fraud score to gauge the likelihood that the participating device 110 is genuine and not participating in fraud. To receive such a fraud score, the requesting device 108 can electronically transmit a scoring request to the processing server 102 using a suitable communication network and method, such as via an application program associated with the processing server 102, a web page, etc. In some cases, the requesting device 108 can submit the new blockchain transaction to a blockchain node 106 and, as part of the submission, request a fraud score, where the blockchain node 106 can electronically transmit the new blockchain transaction or data therefrom to the processing server 102 for scoring using a suitable communication network and method.

To generate fraud scores for new blockchain transactions, the processing server 102 can utilize a fraud detection model that can include a graphical representation of at least a portion of the blockchain network 104 including at least the blockchain node 106 to which the new blockchain transaction has been submitted or is to be submitted. The processing server 102 can receive data from a plurality of different data sources for use in generating the fraud detection model and/or fraud scores. As one data source, the processing server 102 can receive transaction data for a plurality of payment transactions that use fiat currency, such as traditional electronic payment transactions that utilize credit cards, debit cards, etc., which the processing server 102 can receive from a fiat transaction data provider 112. The fiat transaction data provider 112 can be any entity or system that collects transaction data for fiat currency based payment transactions, such as a financial institution, payment network, transaction processor, clearing house, etc. The fiat transaction data provider 112 can collect the transaction data and provide the transaction data to the processing server 102 using a suitable communication network and method. In some cases, the fiat transaction data provider 112 can also provide data associated with individual consumers with permission of the individual consumers, which can include personally identifiable information if approved by the consumer, which can include, for instance, name, address, email address, transaction account number, etc. The transaction data for the fiat currency based payment transactions can include transaction amounts, merchants, financial institutions, times and/or dates, transaction frequencies, geographic locations, currencies, point of sale identifiers, fraud determinations, etc. In some cases, the transaction data can be separated by individual transactions. In other cases, the processing server 102 can receive aggregated transaction data. In cases where approved by the consumer associated with the requesting device 108, the transaction data can include data for individual payment transactions involving the consumer.

As another data source, the processing server 102 can receive transaction data for a plurality of cryptographic currency blockchain transactions from a blockchain data provider 116. The blockchain data provider 116 can be any entity or system that collects transaction data for cryptocurrency blockchain transactions conducted using at least the blockchain associated the blockchain network 104. In some instances, the blockchain data provider 116 can be a blockchain node 106 in the blockchain network 104. In some cases, the blockchain data provider 116 can collect transaction data for blockchain transactions for different blockchains, such as in cases where a blockchain node 106 in the blockchain network 104 operates as a node in additional blockchain networks or for additional blockchains in cases where the blockchain network 104 can operate multiple blockchains. The blockchain data provider 116 can collect the transaction data and provide the transaction data to the processing server 102 using a suitable communication network and method. In some cases, the blockchain data provider 116 can also provide data associated with individual participants with permission of the individual participants, which can include personally identifiable information if approved by the participant, which can include, for instance, public key, telephone number, email address, device identifier for their computing device, etc. The transaction data for the blockchain transactions can include transaction amounts, blockchain nodes, times and/or dates, transaction frequencies, geographic locations, fraud determinations, etc. In some cases, the transaction data can be separated by individual transactions. In other cases, the processing server 102 can receive aggregated transaction data. In cases where approved by the participant associated with the requesting device 108, the transaction data can include data for individual blockchain transactions involving the participant.

As a third data source, the processing server 102 can receive node connectivity data for the blockchain network 104 from a node data provider 114. The node data provider 114 can be any entity or system that collects connectivity data for at least the blockchain network 104. In some instances, the node data provider 114 can be a blockchain node 106 in the blockchain network 104. In some embodiments, the node data provider 114 and blockchain data provider 116 can be the same entity and/or computing system. In some cases, the node data provider 114 can collect connectivity data for additional blockchain networks 104, such as in cases where a blockchain node 106 in the blockchain network 104 operates as a node in additional blockchain networks. The node data provider 114 can collect the node connectivity data and provide the transaction data to the processing server 102 using a suitable communication network and method. The node connectivity data can include data regarding the blockchain nodes 106 in the blockchain network 104 and the connections between nodes. In some embodiments, the node connectivity data can also include information regarding the transaction history of each blockchain node 106. In other embodiments, information regarding the transaction history of each blockchain node can be included in the transaction data received from the blockchain data provider 116, which can be cross-referenced with the node connectivity data received from the node data provider 114.

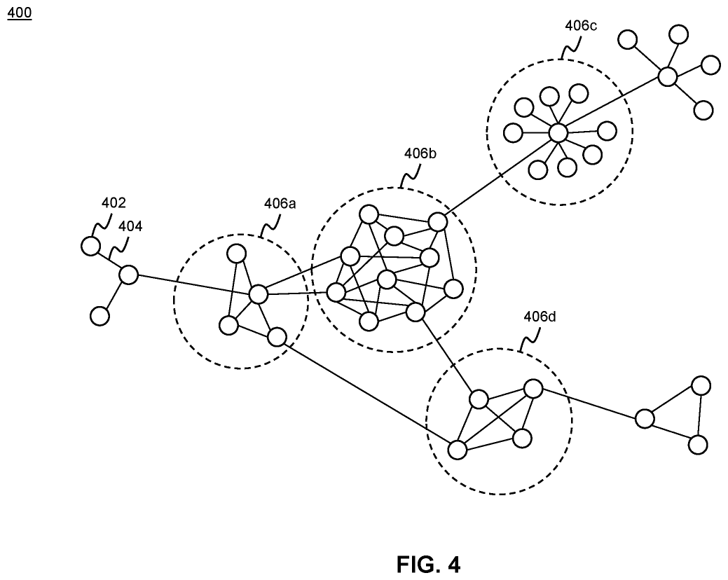

Once the processing server 102 has received the data from multiple data sources, the processing server 102 can generate a fraud detection model. The fraud detection model can use at least the node connectivity data for the blockchain network 104 to generate a model that, when supplied with applicable transaction data for a new blockchain transaction, can be used to determine the likelihood of fraud for the new blockchain transaction. In an exemplary embodiment, the fraud detection model can include a graphical representation of the blockchain nodes 106 in the blockchain network 104 and the connections thereof, such as in the graphical representation 400 illustrated in FIG. 4 and discussed in more detail below. The graphical representation can include a representation of each blockchain node 106 as well as the connections for each blockchain node 106 to other blockchain nodes 106 in the blockchain network 104. The representation can be used in the fraud detection model, where a blockchain node 106 that is connected to a large number of other blockchain nodes 106 that do not have connections to other blockchain nodes 106 can be indicative of fraud, or where a blockchain node 106 that has a history of fraudulent transactions that is connected to other blockchain nodes 106 with histories of fraudulent transactions can be indicative of fraud.

In some cases, the fraud detection model can also utilize the transaction data for the fiat currency based payment transactions and cryptographic currency based blockchain transactions. In such cases, the transaction data can be utilized separate from the graphical representation, such as through one or more algorithms that, when combined with the graphical representation, can be used in the generation of a fraud score. In some embodiments, the processing server 102 can use artificial intelligence and/or machine learning in the generation of the fraud detection model, which can be trained using the transaction data and node connectivity data and past histories regarding the disposition of past blockchain transactions and fiat-based payment transactions as fraudulent or not fraudulent. In some cases, the fraud detection model can also use clustering and/or other modeling techniques in addition to the above for the calculation of fraud scoring, where clustering can include the clustering of blockchain nodes 106, blockchain transactions, fiat-based payment transactions, etc. In embodiments where the processing server 102 can receive transaction data or other data involving the requesting device 108 or participant associated therewith, the processing server 102 can generate a fraud detection model applicable to the individual requesting device 108 or participant associated therewith.

Once the processing server 102 has generated its fraud detection model and received transaction data for a new blockchain transaction from the requesting device 108 or blockchain node 106, the processing server 102 can generate a fraud score for the new blockchain transaction by applying the transaction data for the new blockchain transaction to the fraud detection model. The transaction data for the new blockchain transaction can include a transaction amount, one or more unspent transaction outputs associated with the payer of the blockchain transaction, the destination address of the payee of the blockchain transaction, identifying information for the blockchain node 106 to be used in confirming and adding the new blockchain transaction to the blockchain, and any other suitable data for use in performing the functions discussed herein, such as identifying information for the user of the requesting device 108 and/or user of the participant device 110 if approved by the respective users. The processing server 102 can apply the transaction data to the fraud detection model and generate a fraud score for the new blockchain transaction that indicates a likelihood of fraud for the new blockchain transaction. The fraud score can be increased (e.g., indicating a higher likelihood of fraud) if the requesting device 108 or participating device 110 have been involved in past fraudulent blockchain transactions, if the blockchain node 106 has been involved in past fraudulent blockchain transactions, if the blockchain node 106 is in a cluster indicative of fraudulent activity in the graphical representation, if the transaction frequency for the requesting device 108, participating device 110, or blockchain node 106 is unusually low or high, if the users associated with the requesting device 108 or participating device 110 have been involved in past fraudulent transactions, if the transaction amount for the new blockchain transactions is significantly greater than the average transaction amount for past blockchain or fiat-based payment transactions for the requesting device 108 or participating device 110, if the geographic location for the requesting device 108 or participating device 110 in the new blockchain transaction is different from past geographic locations for the respective device, etc.

The processing server 102 can generate the fraud score for the new blockchain transaction and provide the fraud score in response to the score request. In some cases, the fraud score can be provided back to the requesting device 108 (e.g., directly by the processing server 102 or via the blockchain node 106 used by the requesting device 108). In such cases, the requesting device 108 can prompt the user thereof to approve or deny the new blockchain transaction based on the fraud score. In some such cases, the requesting device 108 can be configured (e.g., based on user instruction) to automatically approve or deny the new blockchain transaction based on the fraud score, such as using a threshold value provided by the user. The requesting device 108 can communicate the approval or denial of the blockchain transaction to the blockchain node 106. If the transaction is denied, then the blockchain node 106 can discard the transaction data for the new blockchain transaction and take no further action. If the transaction is approved, the blockchain node 106 can then confirm the blockchain transaction and add the blockchain transaction to a new block in the blockchain using traditional methods.

In some cases, the fraud score can be provided to the blockchain node 106 by the processing server 102, where the blockchain node 106 can be configured to approve or deny the blockchain transaction on behalf of the requesting device 108. In such cases, the blockchain node 106 can automatically approve or deny the new blockchain transaction based on the received fraud score and a predetermined threshold value, which can be set by the blockchain node 106 or by the requesting device 108, which can be a set threshold value by the requesting device 108 or provided by the requesting device 108 with the new blockchain transaction.

In some embodiments, the fraud score can be provided to another system by the processing server 102 for use in approving or denying the new blockchain transaction. For instance, the system 100 can include a third party system 118, which can be any system or entity that participates in a new blockchain transaction on behalf of or otherwise associated with the requesting device 108. For example, the third party system 118 can be a financial institution, such as an issuing bank, that issues a transaction account (e.g., a blockchain wallet, fiat payment account, etc.) to the requesting device 108 for use in funding the new blockchain transaction. The processing server 102 can transmit the fraud score to the third party system 118, which can use the fraud score in determining whether to approve or deny the new blockchain transaction. In some cases, the third party system 118 can determine whether to approve or deny the new blockchain transaction based on the fraud score itself (e.g., compared to a threshold value). In other cases, the third party system 118 can combine the fraud score with other available data in making the determination to approve or deny the new blockchain transaction. The third party system 118 can transmit its approval or denial directly to the blockchain node 106, to the requesting device 108, or to the processing server 102, for proceeding accordingly.

In some embodiments, the processing server 102 can update the fraud detection model based on the disposition of the new blockchain transaction. For instance, if the user of the requesting device 108 approves the new blockchain transaction, the processing server 102 can modify the fraud detection model such that future transactions similar to the new blockchain transaction have a lower fraud score due to a lower likelihood of fraud. In another example, if the requesting device 108 declines the new blockchain transaction, the processing server 102 can modify the fraud detection model such that future transactions similar to the new blockchain transaction have a higher fraud score due to a higher likelihood of fraud. In some cases, the requesting device 108 can provide feedback regarding the approval or denial of the new blockchain transaction, which can be used to modify the fraud detection model, such as the reasoning of the user for the approval or denial of the new blockchain transaction. In some cases, the processing server 102 can use the disposition of the new blockchain transaction based on the result of the new blockchain transaction itself rather than the user's approval or denial of the new blockchain transaction. In such cases, if the blockchain transaction is conducted without any indication of fraud, the processing server 102 can modify the fraud detection model using the transaction data for the new blockchain transaction as a positive result, while the processing server 102 can modify the fraud detection model using the transaction data for the new blockchain transaction as a negative result if the new blockchain transaction is later discovered to involve fraud. In latter cases, the fraud detection model can be updated based on the source of the fraud for the new blockchain transaction (e.g., the blockchain node 106, requesting device 108, participating device 110, etc.).

In some embodiments, the processing server 102 can be configured to update the fraud detection model when new data is received. For instance, the processing server 102 can receive new transaction data or new node connectivity data and can update the fraud detection model as a result. In some instances, the processing server 102 can update the fraud detection model any time new data is received. In other instances, the processing server 102 can update the fraud detection at regular intervals (e.g., hourly, daily, weekly, etc.). In some embodiments, the fiat transaction data provider 112, node data provider 114, and/or blockchain data provider 116 can provide updated data to the processing server 102 any time updated data is available, or at regular intervals.

The methods and systems discussed herein provide for fraud scoring for cryptographic currency transactions that use multiple data sources and a graphical representation to provide fraud scores to assist in the approval or denial of new blockchain transactions. By using data from multiple sources that include more than just blockchain transaction data, a more comprehensive and accurate fraud score can be obtained, such as in cases where a participant can have a long history of successful fiat currency based transactions but is new to the blockchain. Additionally, the use of a graphical representation can provide a more accurate fraud score, particularly related to the involvement of blockchain nodes where fraudulent activity can be indicated only through the graphical representation. As a result, the methods and systems discussed herein provide a significant improvement over existing systems in the fraud scoring of blockchain transactions that can benefit all participants of a blockchain including the blockchain network 104 itself by discouraging and preventing transactions by fraudulent or compromised blockchain nodes 106.

### Processing Server

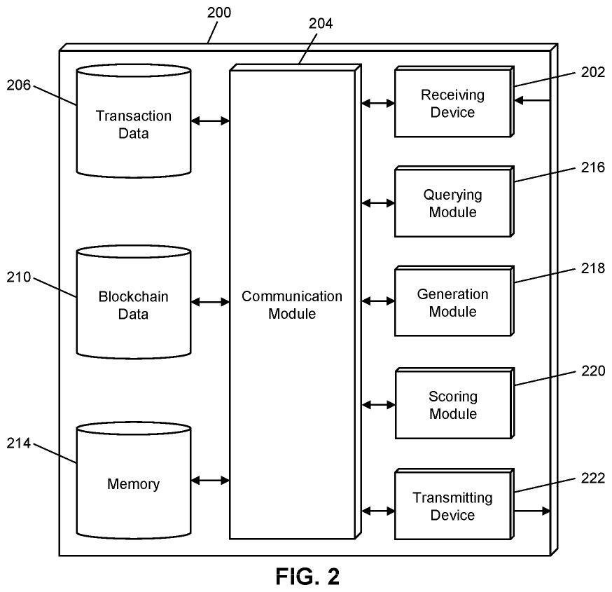

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 700 illustrated in FIG. 7 and discussed in more detail below can be a suitable configuration of the processing server 102. In some cases, other components of the system 100, such as the blockchain nodes 106, requesting device 108, participating device 110, fiat transaction data provider 112, node data provider 114, and blockchain data provider 116, can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, requesting devices 108, participating devices 110, fiat transaction data providers 112, node data providers 114, blockchain data providers 116, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that can superimposed or otherwise encoded with blockchain data, new blockchain transactions, scoring requests, transaction data for past cryptographic currency blockchain transactions, node connectivity data for blockchain networks 104, disposition notifications for past blockchain transactions, etc. The receiving device 202 can also be configured to receive data signals electronically transmitted by requesting devices 108 and participating devices 110, which can be superimposed or otherwise encoded with new blockchain transactions, scoring requests, disposition notifications, personally identifiable information approvals, transaction histories, etc. The receiving device can also be configured to receive data signals electronically transmitted by other computing systems including fiat transaction data providers 112, node data providers 114, and blockchain data providers 116 that can be superimposed or otherwise encoded with transaction data, node connectivity data, and other data for use in the generation of fraud detection models and generation of fraud scores for new blockchain transactions, as discussed herein.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, scoring module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include transaction data 206, which can be stored in a memory 214 of the processing server 102 or stored in a separate area within the processing server 102 or accessible thereby. The transaction data 206 can include data associated with one or more fiat currency based payment transactions, one or more cryptographic currency based blockchain transactions, individual transaction accounts, individual blockchain wallets, individual consumers of payment transactions or participants of blockchain transactions, etc. The transaction data 206 can include transaction amounts, transaction times and/or dates, transaction frequencies, merchant data, participant data, fraud scores, fraud determinations, fraud dispositions, and other data as discussed herein.

The processing server 102 can also include blockchain data 210, which can be stored in a memory 214 of the processing server 102 or stored in a separate area within the processing server 102 or accessible thereby. The blockchain data 210 can include a blockchain, which may be comprised of a plurality of blocks and be associated with the blockchain networks 104 and a core blockchain. In some cases, the blockchain data 210 can further include any other data associated with the blockchain and management and performance thereof, such as block generation algorithms, digital signature generation and confirmation algorithms, communication data for blockchain nodes 106, smart contracts, cryptographic keys, etc. The blockchain data 210 can also include data used by the processing server 102 for actions associated with a blockchain, such as cryptographic key pairs for blockchain wallets, public keys for generating destination addresses or validating digital signatures, transaction histories, cryptocurrency amounts, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, fraud scoring rules, artificial intelligence data, machine learning data, artificial intelligence models, fraud detection models, etc.

The processing server 102 can include a querying module 216. The querying module 216 can be configured to execute queries on databases to identify information. The querying module 216 can receive one or more data values or query strings and can execute a query string based thereon on an indicated database, such as the memory 214 of the processing server 102 to identify information stored therein. The querying module 216 can then output the identified information to an appropriate engine or module of the processing server 102 as necessary. The querying module 216 can, for example, execute a query on the memory 214 to identify a fraud detection model for use in generating a fraud score for a new blockchain transaction.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate fraud detection models that can include graphical representations generated by the generation module 218 based on node connectivity data and any other data discussed herein. The generation module 218 can be further configured to update a generated graphical representation and/or fraud detection model using new or updated transaction data, node connectivity data, etc.

The processing server 102 can also include a scoring module 220. The validation module 220 can be configured to score new blockchain transactions for likelihood of fraud for the processing server 102 as part of the functions discussed herein. The scoring module 220 can receive a request to score a new blockchain transaction as input, which can also include the transaction data for the new blockchain transaction to be used in determining the score, can score the new blockchain transaction as requested, and can output the score to another module or engine of the processing server 102.

The processing server 102 can also include a transmitting device 222. The transmitting device 222 can be configured to transmit data over one or more networks via one or more network protocols. In some instances, the transmitting device 222 can be configured to transmit data to blockchain nodes 106, requesting devices 108, participating devices 110, fiat transaction data providers 112, node data providers 114, blockchain data providers 116, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 that are superimposed or otherwise encoded with blockchain data requests, node connectivity requests, fraud score determinations, fraud disposition requests, etc. The transmitting device 222 can also be configured to electronically transmit data signals to requesting devices 108 and/or participating devices 110, which can be superimposed or otherwise encoded with fraud score determinations, transaction data requests, personally identifiable information approval requests, blockchain data requests, etc. The transmitting device 222 can also be configured to electronically transmit data signals to fiat transaction data providers 112, node data providers 114, and/or blockchain data providers 116 that can be superimposed or otherwise encoded with data requests to request updated transaction data and/or node connectivity data.

### Process for Generation of a Fraud Detection Model

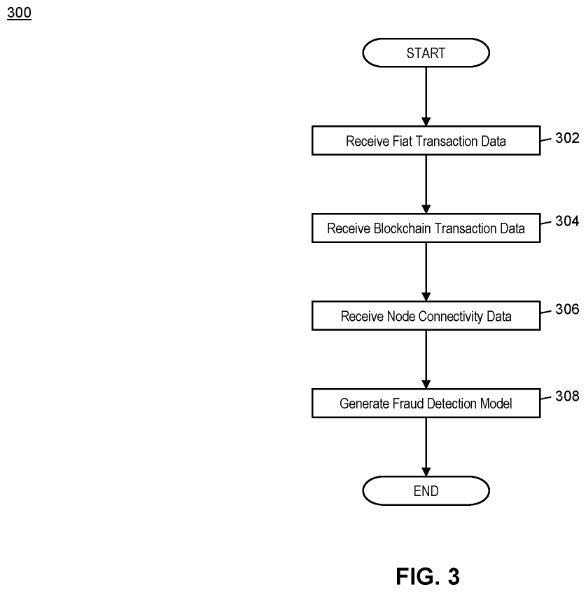

FIG. 3 illustrates a process 300 performed by the processing server 102 in the system 100 of FIG. 1 for the generation of a fraud detection model using a graphical representation and data from multiple data sources for use in fraud scoring cryptographic currency transactions.

The process 300 can begin and, in step 302, the receiving device 202 of the processing server 102 can receive transaction data for a plurality of fiat currency based payment transactions from a fiat transaction data provider 112. In some cases, the transaction data can be broken up in individual payment transactions. In other cases, the transaction data can be aggregated. In some instances, the transaction data can include additional data associated with individual transaction accounts, such as in cases where a consumer associated with each transaction account has provided explicitly approval for use thereof in fraud scoring. The querying module 216 of the processing server 102 can execute a query to insert the received transaction data in the transaction data 206 of the processing server 102.

In step 304, the receiving device 202 of the processing server 102 can receive transaction data for a plurality of cryptographic currency based blockchain transactions from a blockchain data provider 116. In some cases, the transaction data can be broken up in individual blockchain transactions. In other cases, the transaction data can be aggregated. In some instances, the transaction data can include additional data associated with individual blockchain wallets, such as in cases where a user associated with each blockchain wallet has provided explicitly approval for use thereof in fraud scoring. The querying module 216 of the processing server 102 can execute a query to insert the received transaction data in the transaction data 206 of the processing server 102.

In step 306, the receiving device 202 of the processing server 102 can receive node connectivity data for the blockchain network 104 from a node data provider 114. The node connectivity data can include data regarding one or more blockchain nodes 106 in the blockchain network 104 and communication paths between the blockchain nodes 106. The querying module 216 of the processing server 102 can execute a query to insert the received node connectivity data in the blockchain data 210 or memory 214 of the processing server 102.

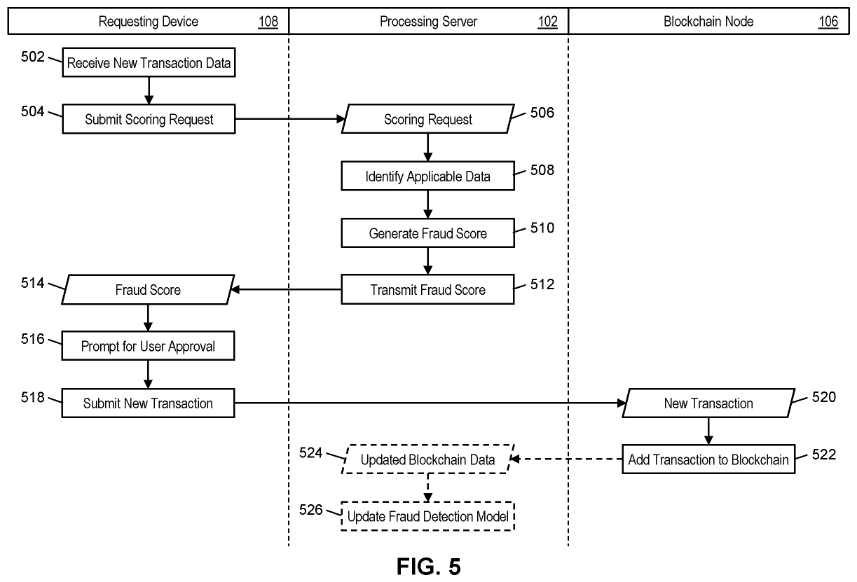

In step 308, the generation module 218 of the processing server 102 can generate a fraud detection model. The fraud detection model can include at least a graphical representation of the blockchain nodes 106 in the blockchain network 104, generated based on the received node connectivity data. The fraud detection model can be based on the graphical representation as well as the received transaction data for the fiat currency based payment transactions and cryptographic currency blockchain transactions. In some cases, the graphical representation can utilize clustering for the blockchain nodes 106. The fraud detection model can be generated such that, when transaction data for a new blockchain transaction is applied, a fraud score can be generated that indicates the likelihood of fraud for the new blockchain transaction based on a combination of the transaction data and graphical representation of the nodes in the blockchain network 104. In some embodiments, the generation module 218 of the processing server 102 can use artificial intelligence and/or machine learning in the generation of the fraud detection model. In some cases, the processing server 102 can use one or more specific artificial intelligence models in generating the fraud detection model. In some instances, weighting can be used for the transaction data and/or node connectivity data in the generation of the fraud detection model. The processing server 102 can then be ready to use the generated fraud detection model in fraud scoring future blockchain transactions, as discussed in the process illustrated in FIG. 5 and discussed in more detail below.

### Graphical Representation of Node Connectivity

FIG. 4 illustrates a graphical representation 400 of node connectivity in a blockchain network 104 for use by the processing server 102 in the generation of a fraud detection model and fraud scoring of new blockchain transactions. It will be apparent to persons having skill in the relevant art that the graphical representation 400 in FIG. 4 is illustrative only and that blockchain networks 104 can include significantly more or less blockchain nodes 106, which can have significantly more or less connections with other blockchain nodes 106.

The graphical representation 400 includes a representation of a plurality of blockchain nodes 106 in the blockchain network 104 as nodes 402. The graphical representation 400 also includes an illustration of connections 404 between nodes 402, which represents a communication path between two blockchain nodes 106 in the blockchain network 104. The communication path can be an ongoing communication channel established between the two blockchain nodes 106 or indicative of a past communication between the two blockchain nodes 106, such as a past confirmation request or response message. In some cases, the processing server 102 can use a time cutoff in determining if a connection 404 is to be illustrated in the graphical representation 400 for two nodes 402. For example, a connection 404 can be illustrated in cases where a communication has been exchanged between the two nodes 402 within a predetermined period of time (e.g., the most recent 24 hours).

As illustrated, some nodes 402 can have only a single connection with another node 402, while other nodes 402 can have connections with several other nodes 402. A node 402 with only a single connection can be a new blockchain node 106 that has not established communication channels with additional blockchain nodes 106, but can also be indicative of a blockchain node 106 that is participating in fraud. The fraud detection model can affect the fraud score for a new blockchain transaction based on the blockchain node 106 to which the new blockchain transaction was submitted by the requesting device 108 or received from by the processing server 102 as it is illustrated in the graphical representation, where the number of connections 404 for the associated node 402 and location of the node 402 in the representation can positively or negatively affect the fraud score.

In exemplary embodiments, the graphical representation 400 can utilize clustering. Clustering can comprise the grouping of one or more nodes 402 into a cluster 406 based on shared connections 404, geographic location, communication frequency, and other suitable data. In the illustrated example, the generation module 218 can generate four clusters 406, illustrated as clusters 406a, 406b, 406c, and 406d. The fraud detection module can utilize the clusters 406 when determining fraud score, where attributes of a cluster 406 can positively or negatively affect fraud score and where attributed of nodes 402 in a cluster 406 can positively or negatively affect the fraud scores of other nodes 402 in the same cluster 406.

In the illustrated example, cluster 406b can be associated with the lowest likelihood of fraud due to the number of nodes 402 in the cluster 406b and the number of connections 404 between each of the nodes 402. Cluster 406b includes ten different nodes 402 and where each of the nodes 402 includes three or more connections 404 to other nodes 402 in the cluster 406, which can represent a low likelihood of fraud due to the difficulty in passing a fraudulent transaction through the cluster 406. Clusters 406a and 406d can represent a higher likelihood of fraud than cluster 406b due to a lower number of nodes 402 and connections 404, but where the likelihood of fraud can be below a threshold value indicative of fraud due to each node 402 having multiple connections 404 and each cluster 406 having connections 404 to multiple additional clusters 406.

In the illustrated example, cluster 406c can indicate the highest likelihood of fraud. The higher likelihood of fraud can be indicated as a result of the cluster 406c including several nodes 402 that only share a connection 404 with the single, central node 402 in the cluster 406c and where the central node 402 in the cluster 406c has a minimal number of connections 404 with other nodes 402 outside of the cluster 406c. This can indicate an attempt for a nefarious actor to pass a fraudulent transaction onto the blockchain via the central node in the cluster 406c that gets confirmation from compromised blockchain nodes 106 as the other nodes 402 in the cluster 406c and then communications the confirmations to nodes 402 in other clusters 406.

### Process for Fraud Scoring a Cryptocurrency Blockchain Transaction

FIG. 5 illustrates a method 500 for the fraud scoring of a cryptographic currency blockchain transaction using a fraud detection model and graphical representation, such as the fraud detection model generated in the process 300 of FIG. 3 using the graphical representation 400 of FIG. 4, as performed in the system 100 of FIG. 1.

In step 502, the requesting device 108 can receive data from a new blockchain transaction, which can include data from a recipient (e.g., participating device 110), such as a destination address, and data input by a user of the requesting device 108, such as a transaction amount and unspent transaction outputs. In step 504, the requesting device 108 can submit a scoring request for the new blockchain transaction to the processing server 102 using a suitable communication network and method. In some cases, the scoring request can be submitted to the processing server 102 by the requesting device 108 via a blockchain node 106 that is to add the new blockchain transaction to the blockchain if approved. In other cases, the scoring request can be submitted to the processing server 102 directly from the requesting device 108. In such cases, the scoring request can also include an identifier associated with the blockchain node 106 to be used by the requesting device 108 in adding the new blockchain transaction to the blockchain if approved.

In step 506, the receiving device 202 of the processing server 102 can receive the scoring request from the requesting device 108. In step 508, the processing server 102 can identify all applicable data to be used in fraud scoring the new blockchain transaction. The applicable data can be an applicable fraud detection model, which can be based on the transaction data for the new blockchain transaction, such as in cases where the fraud detection model can vary based on the transaction amount or be a fraud detection model specifically generated for the requesting device 108. The applicable data can also include transaction data for fiat currency based payment transactions involving a user associated with the requesting device 108 and cryptographic currency blockchain transactions involving the requesting device 108 in cases where the user has provided approval of use of such data.

In step 510, the scoring module 220 of the processing server 102 can apply the received new blockchain transaction data and identified applicable data to the identified fraud detection model to generate a fraud score for the new blockchain transaction. The fraud score can indicate a likelihood that the new blockchain transaction involves fraud, which can be indicated to be perpetrated by the requesting device 108, participating device 110 or blockchain node 106. In step 512, the transmitting device 222 of the processing server 102 can electronically transmit the generated fraud score to the requesting device 108 using a suitable communication network and method. The generated fraud score can be directly transmitted to the requesting device 108 by the processing server 102, or via the blockchain node 106, as applicable.

In step 514, the requesting device 108 can receive the fraud score generated for the new blockchain transaction from the processing server 102. In step 516, the requesting device 108 can display the received fraud score to a user thereof and prompt the user to approve the new blockchain transaction. If the fraud score is suitable to the user the user can approve the new blockchain transaction, which can cause the requesting device 108 to, in step 518, submit the new blockchain transaction to the identified blockchain node 106 for addition to the blockchain associated with the blockchain network 104. In step 520, the blockchain node 106 can receive the new blockchain transaction from the requesting device 108. In step 522, the blockchain node 106 can confirm the new blockchain transaction and add the new blockchain transaction to the blockchain using traditional methods.

In some embodiments, the process can further include steps 524 and 526. In step 524, the receiving device 202 of the processing server 102 can receive updated blockchain transaction data from the blockchain node 106, a blockchain data provider 116, or by identifying new blockchain data stored in the blockchain. The updated blockchain transaction data can include at least the new blockchain transaction as being successfully approved by the requesting device 108 and added to the blockchain. In step 526, the generation module 218 of the processing server 102 can update the graphical representation and fraud detection model based on the updated blockchain transaction data. For instance, because the new blockchain transaction was approved and successfully processed, the blockchain node 106 and cluster 406 including the blockchain node 106 in the graphical representation can have a lower likelihood of fraud, and the fraud detection model can be updated such that future fraud scores involving the blockchain node 106 and its cluster can yield lower fraud scores.

### Exemplary Method for Fraud Scoring Blockchain Transactions

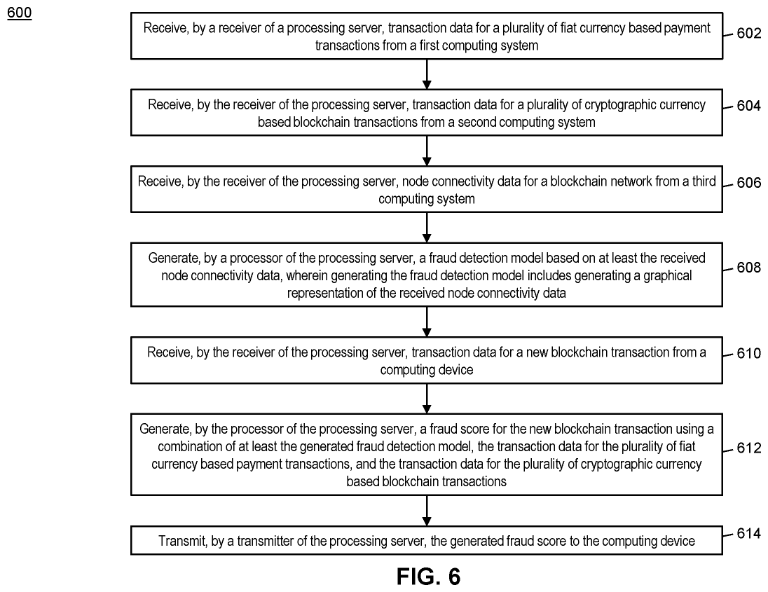

FIG. 6 illustrates a method 600 for the fraud scoring of a cryptographic currency transaction using multiple data sets and graphical modeling.

In step 602, transaction data for a plurality of fiat currency based payment transactions can be received by a receiver (e.g., receiving device 202) of a processing server (e.g., processing server 102) from a first computing system (e.g., fiat transaction data provider 112). In step 604, transaction data for a plurality of cryptographic currency based blockchain transactions can be received by the receiver of the processing server from a second computing system (e.g., blockchain data provider 116). In step 606, node connectivity data for a blockchain network (e.g., blockchain network 104) can be received from a third computing system (e.g., node data provider 114).

In step 608, a fraud detection model can be generated by a processor (e.g., generation module 218) of the processing server based on at least the received node connectivity data, wherein generating the fraud detection model includes generating a graphical representation (e.g., graphical representation 400) of the received node connectivity data. In step 610, transaction data for a new blockchain transaction can be received by the receiver of the processing server from a computing device (e.g., requesting device 108). In step 612, a fraud score can be generated by the processor (e.g., scoring module 220) of the processing server for the new blockchain transaction using a combination of at least the generated fraud detection model, the transaction data for the plurality of fiat currency based payment transactions, and the transaction data for the plurality of cryptographic currency based blockchain transactions. In step 614, the generated fraud score can be transmitted by a transmitter (e.g., transmitting device 222) of the processing server to the computing device.

In one embodiment, the graphical representation can include at least a visual representation of each of a plurality of blockchain nodes in the blockchain network and connections between one or more of the plurality of blockchain nodes. In a further embodiment, the visual representation of each of the plurality of blockchain nodes included in the graphical representation can indicate a likelihood of involvement of the respective blockchain node in fraudulent activity based on the received transaction data for the plurality of cryptographic currency based blockchain transactions. In some embodiments, the fraud score can indicate a higher likelihood of fraud if the transaction data for the new blockchain transaction identifies a blockchain node in the blockchain network with a higher likelihood of fraud based on the node connectivity data for the blockchain network. In further embodiments, the higher likelihood of fraud based on the node connectivity data can be indicated by the blockchain node or a secondary blockchain node having a direct connection to the blockchain node having a number of connected nodes without additional connections in the blockchain network greater than a predetermined threshold value.

In one embodiment, the fraud detection model can be generated using artificial intelligence. In some embodiments, the method 600 can also include modifying, by the processor of the processing server, the generated fraud detection model based on the generated fraud score. In a further embodiment, the method 600 can even further include receiving, by the receiver of the processing server, a message indicating disposition of the new blockchain transaction, wherein modifying the generated fraud detection model can be further based on the indicated disposition of the new blockchain transaction.

### Computer System Architecture

FIG. 7 illustrates a computer system 700 in which embodiments of the present disclosure, or portions thereof, can be implemented as computer-readable code. For example, processing server 102, blockchain nodes 106, requesting device 108, participating device 110, fiat transaction data provider 112, node data provider 114, and blockchain data provider 116 can be implemented in the computer system 700 using hardware, non-transitory computer readable media having instructions stored thereon, or a combination thereof and can be implemented in one or more computer systems or other processing systems. Hardware can embody modules and components used to implement the methods of FIGS. 3, 5, and 6.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multi-processor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 704 can be a special purpose or a general purpose processor device specifically configured to perform the functions discussed herein. The processor device 704 can be connected to a communications infrastructure 706, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 can also include a main memory 708 (e.g., random access memory, read-only memory, etc.), and can also include a secondary memory 710. The secondary memory 710 can include the hard disk drive 712 and a removable storage drive 714, such as a floppy disk drive, a magnetic tape drive, an optical disk drive, a flash memory, etc.

The removable storage drive 714 can read from and/or write to the removable storage unit 718 in a well-known manner. The removable storage unit 718 can include a removable storage media that can be read by and written to by the removable storage drive 714. For example, if the removable storage drive 714 is a floppy disk drive or universal serial bus port, the removable storage unit 718 can be a floppy disk or portable flash drive, respectively. In one embodiment, the removable storage unit 718 can be non-transitory computer readable recording media.

In some embodiments, the secondary memory 710 can include alternative means for allowing computer programs or other instructions to be loaded into the computer system 700, for example, the removable storage unit 722 and an interface 720. Examples of such means can include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 700 can also include a communications interface 724. The communications interface 724 can be configured to allow software and data to be transferred between the computer system 700 and external devices. Exemplary communications interfaces 724 can include a modem, a network interface (e.g., an Ethernet card), a communications port, a PCMCIA slot and card, etc. Software and data transferred via the communications interface 724 can be in the form of signals, which can be electronic, electromagnetic, optical, or other signals as will be apparent to persons having skill in the relevant art. The signals can travel via a communications path 726, which can be configured to carry the signals and can be implemented using wire, cable, fiber optics, a phone line, a cellular phone link, a radio frequency link, etc.

The computer system 700 can further include a display interface 702. The display interface 702 can be configured to allow data to be transferred between the computer system 700 and external display 730. Exemplary display interfaces 702 can include high-definition multimedia interface (HDMI), digital visual interface (DVI), video graphics array (VGA), etc. The display 730 can be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 708 and secondary memory 710, which can be memory semiconductors (e.g., DRAMs, etc.). These computer program products can be means for providing software to the computer system 700. Computer programs (e.g., computer control logic) can be stored in the main memory 708 and/or the secondary memory 710. Computer programs can also be received via the communications interface 724. Such computer programs, when executed, can enable computer system 700 to implement the present methods as discussed herein. In particular, the computer programs, when executed, can enable processor device 704 to implement the methods illustrated by FIGS. 3, 5, and 6, as discussed herein. Accordingly, such computer programs can represent controllers of the computer system 700. Where the present disclosure is implemented using software, the software can be stored in a computer program product and loaded into the computer system 700 using the removable storage drive 714, interface 720, and hard disk drive 712, or communications interface 724.

The processor device 704 can comprise one or more modules or engines configured to perform the functions of the computer system 700. Each of the modules or engines can be implemented using hardware and, in some instances, can also utilize software, such as corresponding to program code and/or programs stored in the main memory 708 or secondary memory 710. In such instances, program code can be compiled by the processor device 704 (e.g., by a compiling module or engine) prior to execution by the hardware of the computer system 700. For example, the program code can be source code written in a programming language that is translated into a lower level language, such as assembly language or machine code, for execution by the processor device 704 and/or any additional hardware components of the computer system 700. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for fraud scoring cryptographic currency transactions using multiple data sets and graphical modeling. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for fraud scoring a cryptographic currency transaction using multiple data sets and graphical modeling, comprising:
receiving, by a receiver of a processing server, transaction data for a plurality of fiat currency based payment transactions from a first computing system;
receiving, by the receiver of the processing server, transaction data for a plurality of cryptographic currency based blockchain transactions from a second computing system;
receiving, by the receiver of the processing server, node connectivity data for a blockchain network from a third computing system;
generating, by a processor of the processing server, a fraud detection model based on at least the received node connectivity data, wherein generating the fraud detection model includes generating a graphical representation of the received node connectivity data;
receiving, by the receiver of the processing server, transaction data for a new blockchain transaction from a computing device;
generating, by the processor of the processing server, a fraud score for the new blockchain transaction using a combination of at least the generated fraud detection model, the transaction data for the plurality of fiat currency based payment transactions, and the transaction data for the plurality of cryptographic currency based blockchain transactions; and
transmitting, by a transmitter of the processing server, the generated fraud score to the computing device.

2. The method of claim 1, wherein the graphical representation includes at least a visual representation of each of a plurality of blockchain nodes in the blockchain network and connections between one or more of the plurality of blockchain nodes.

3. The method of claim 2, wherein the visual representation of each of the plurality of blockchain nodes included in the graphical representation indicates a likelihood of involvement of the respective blockchain node in fraudulent activity based on the received transaction data for the plurality of cryptographic currency based blockchain transactions.

4. The method of claim 1, wherein the fraud score indicates a higher likelihood of fraud if the transaction data for the new blockchain transaction identifies a blockchain node in the blockchain network with a higher likelihood of fraud based on the node connectivity data for the blockchain network.

5. The method of claim 4, wherein the higher likelihood of fraud based on the node connectivity data is indicated by the blockchain node or a secondary blockchain node having a direct connection to the blockchain node having a number of connected nodes without additional connections in the blockchain network greater than a predetermined threshold value.

6. The method of claim 1, wherein the fraud detection model is generated using artificial intelligence.

7. The method of claim 1, further comprising:
modifying, by the processor of the processing server, the generated fraud detection model based on the generated fraud score.

8. The method of claim 7, further comprising:
receiving, by the receiver of the processing server, a message indicating disposition of the new blockchain transaction, wherein
modifying the generated fraud detection model is further based on the indicated disposition of the new blockchain transaction.

9. A system for fraud scoring a cryptographic currency transaction using multiple data sets and graphical modeling, comprising:
a first computing system;
a second computing system;
a third computing system;
a computing device;
a blockchain network; and
a processing server, the processing server including
a receiver receiving transaction data for a plurality of fiat currency based payment transactions from the first computing system, transaction data for a plurality of cryptographic currency based blockchain transactions from the second computing system, and node connectivity data for the blockchain network from the third computing system,
a processor generating a fraud detection model based on at least the received node connectivity data, wherein generating the fraud detection model includes generating a graphical representation of the received node connectivity data, and
a transmitter, wherein
the receiver of the processing server further receives transaction data for a new blockchain transaction from the computing device,
the processor of the processing server generates a fraud score for the new blockchain transaction using a combination of at least the generated fraud detection model, the transaction data for the plurality of fiat currency based payment transactions, and the transaction data for the plurality of cryptographic currency based blockchain transactions, and
the transmitter of the processing server transmits the generated fraud score to the computing device.

10. The system of claim 9, wherein the graphical representation includes at least a visual representation of each of a plurality of blockchain nodes in the blockchain network and connections between one or more of the plurality of blockchain nodes.

11. The system of claim 10, wherein the visual representation of each of the plurality of blockchain nodes included in the graphical representation indicates a likelihood of involvement of the respective blockchain node in fraudulent activity based on the received transaction data for the plurality of cryptographic currency based blockchain transactions.

12. The system of claim 9, wherein the fraud score indicates a higher likelihood of fraud if the transaction data for the new blockchain transaction identifies a blockchain node in the blockchain network with a higher likelihood of fraud based on the node connectivity data for the blockchain network.

13. The system of claim 12, wherein the higher likelihood of fraud based on the node connectivity data is indicated by the blockchain node or a secondary blockchain node having a direct connection to the blockchain node having a number of connected nodes without additional connections in the blockchain network greater than a predetermined threshold value.

14. The system of claim 9, wherein the fraud detection model is generated using artificial intelligence.

15. The system of claim 9, wherein the processor of the processing server modifies the generated fraud detection model based on the generated fraud score.

16. The system of claim 15, wherein
the receiver of the processing server receives a message indicating disposition of the new blockchain transaction, and
modifying the generated fraud detection model is further based on the indicated disposition of the new blockchain transaction.
